(19) United States
(12) Patent Application Publication
(10) Pub. No.: US 2002/0146113 A1
(43) Pub. Date: Oct. 10, 2002

(54) Asymmetric digital subscriber line telephone filter

(76) Inventor: Max Chu, Taipei (TW)

Correspondence Address: VARNDELL & VARNDELL, PLLC, 106-A South Columbus Street, Alexandria, VA, 22314, US

(21) Appl. No.: 09/826,208

(22) Filed: Apr. 5, 2001

(51) Int. Cl. H04M 1/00; H04M 9/00

(52) U.S. Cl. 379/399.01

(57) ABSTRACT

An symmetric digital subscriber line telephone filter includes a bottom cover shell and a top cover shell fastened together by a hook joint to hold a circuit board in between the circuit board having two RJ45 jacks adapted to receive an external symmetric digital subscriber line and a telephone line, and a communication cable electrically connected to the RJ45 jacks of the circuit board and extended to the outside for connection to an external RJ45 jack.

### BACKGROUND AND SUMMARY OF THE INVENTION

The present invention relates to an asymmetric digital subscriber line telephone filter and, more particularly, to such an asymmetric digital subscriber line telephone filter which has a communication cable with a RJ45 plug for connection to the RJ45 jack of an asymmetric digital subscriber line in the wall, and two RJ45 jacks adapted to receive a telephone line and an external asymmetric digital subscriber line.

Asymmetric digital subscriber lines are intensively used nowadays.

However, the use of an asymmetric digital subscriber line cannot simultaneously receives a telephone and a fax machine or modem. In order to let an asymmetric digital subscriber line simultaneously receive a telephone and a fax machine or modem, a T-adapter may be used. As illustrated in FIG. 1, the T-adapter 71 is connected to a module jack 81 in the wall 8 to receive the module plug 721 of a filter 72, which in turns receives the module plug 731 of a telephone line 73, and the module plug 741 of an external asymmetric digital subscriber line communication line 74. This arrangement uses more number of parts. Further, the use of the T-adapter 71 and the filter 72 requires much installation space.

The present invention has been accomplished to provide an asymmetric digital subscriber line telephone filter, which eliminates the drawbacks of the use of the conventional T-adapter. According to the present invention, the asymmetric digital subscriber line telephone filter comprises a RJ45 plug disposed at one side for connection to an asymmetric digital subscriber line jack in the wall, and two RJ45 jacks disposed at an opposite side in communication with the RJ45 plug and adapted to receive the RJ45 plug of a telephone line and the RJ45 plug of an external asymmetric digital subscriber line. Because the invention eliminates the use of the aforesaid T-adapter, less number of parts is used, and less installation space is needed.

### BRIEF DESCRIPTION OF THE DRAWING

FIG. 1 is a circuit block diagram showing the application of the prior art design.

FIG. 2 is a circuit block diagram showing the application of the present invention.

FIG. 3 is an exploded view of the present invention.

FIG. 3A is an enlarged view of a part of FIG. 3.

FIG. 4 is an exploded view of the present invention when viewed from another angle.

FIG. 4A is an enlarged view of a part of FIG. 4.

FIG. 5 is a perspective view of the circuit board according to the present invention.

FIG. 6 is a perspective view of the asymmetric digital subscriber line telephone filter according to the present invention.

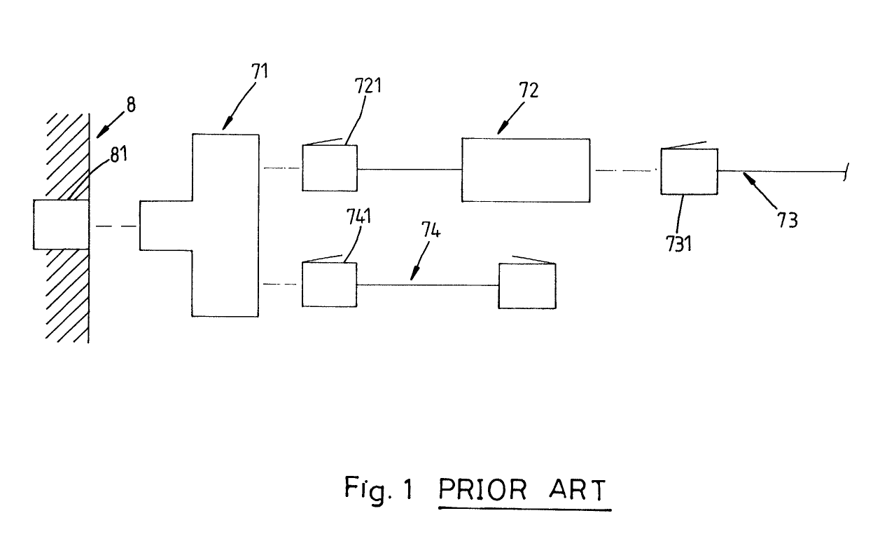

### DETAILED DESCRIPTION OF THE PREFERRED EMBODIMENT

Referring to FIGS. from 2 through 6, an asymmetric digital subscriber line telephone filter in accordance with the present invention is generally comprised of a top cover shell 1, a circuit board 2, and a bottom cover shell 3.

The top cover shell 1 comprises a plurality of hook holes 12 bilaterally disposed at the bottom side thereof, a front opening 13 transversely disposed at the front side thereof, and two bottom locating rods 11. The bottom locating rods 11 each have a round pin 111 axially downwardly extended from the respective bottom end. The diameter of the round pin 111 is relatively smaller than the respective bottom locating rods 11. The circuit board 2 comprises a winding 202, a capacitor 203, two through holes 201, two RJ45 jacks 21, and a communication cable 22. The communication cable 22 has one end electrically soldered to the circuit board 2, and an opposite end terminating in a RJ45 plug 221. The bottom cover shell 3 comprises a plurality of top hooks 32 bilaterally disposed at the top side thereof corresponding to the hook holes 12 of the top cover shell 1, a front opening 33 transversely disposed at the front side thereof corresponding to the front opening 13 of the top cover shell 1, and two upright locating posts 31. The upright locating posts 31 each define a plughole 311.

Referring to FIGS. from 2 through 6 again, the circuit board 2 is put in the bottom cover shell 3 and supported on the upright locating posts 31, and then the top cover shell 1 is closed on the bottom cover shell 3 to force the round pin 111 of each of the bottom locating rods 11 into the plughole 311 of each of the upright locating posts 31 and the hook holes 12 into engagement with the top hooks 32 of the bottom cover shell 3 respectively. When assembled, the receiving side 211 of each RJ45 jack 21 of the circuit board 2 is disposed in the openings 13 and 33 of the cover shells 1 and 3.

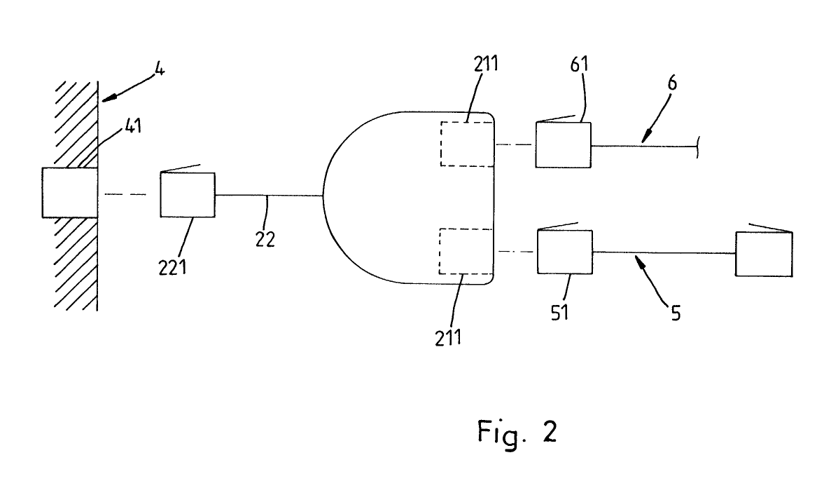

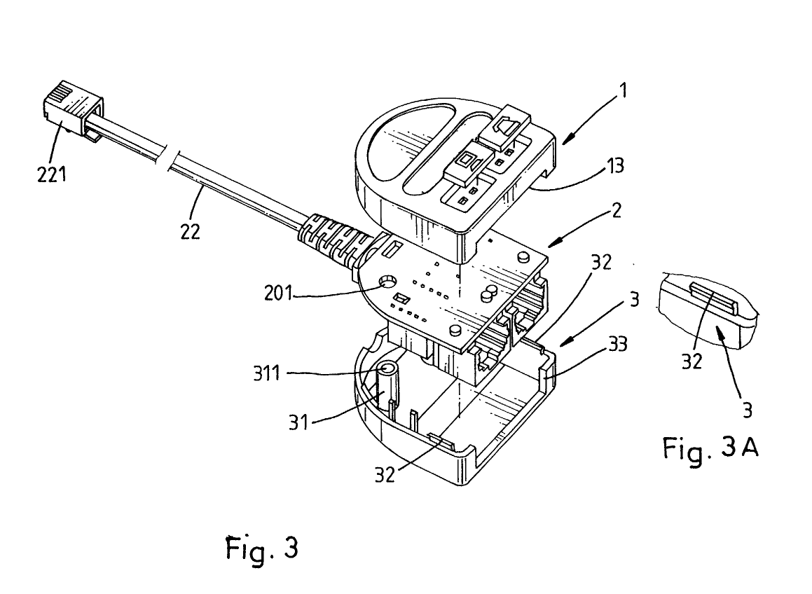

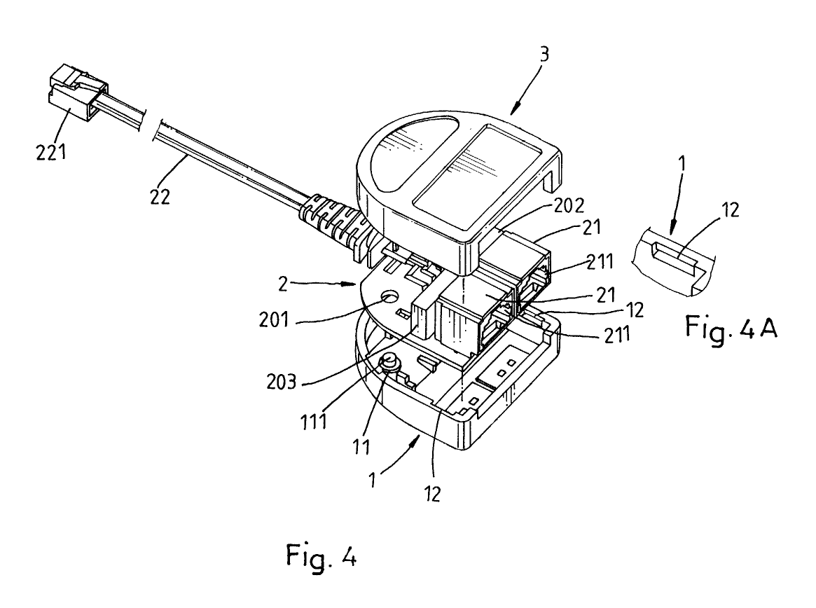

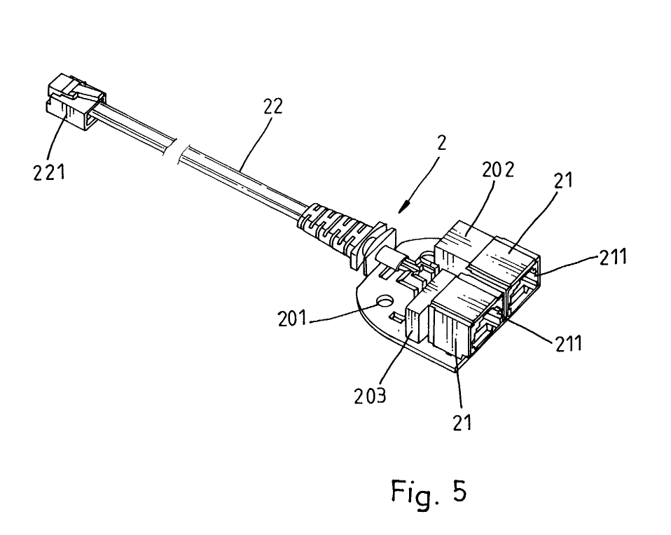

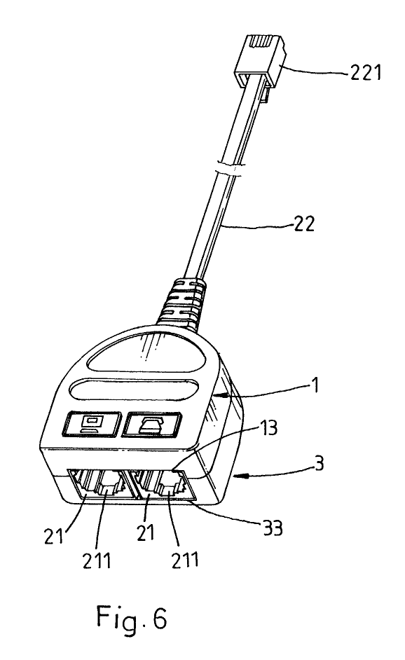

Referring to FIG. 2 again, when in use, the RJ45 plug 221 of the communication cable 22 is fastened to the RJ45 jack 41 of the symmetric digital subscriber line in the wall 4, one of the RJ45 jacks 21 of the circuit board 2 receives the RJ45 plug 51 of the symmetric digital subscriber line communication line 5, and the other of the RJ45 jacks 21 of the circuit board 2 receives the RJ45 plug 61 of the telephone line (or fax communication line/modem communication line) 6.

A prototype of symmetric digital subscriber line telephone filter has been constructed with the features of FIGS. 2˜6. The symmetric digital subscriber line telephone filter functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims. For example, screw means may be used to fixedly secure the top cover shell 1 to the bottom cover shell 3 instead of the engagement between the hooks 32 and the hook holes 12.

1. An symmetric digital subscriber line telephone filter comprising a bottom cover shell, a circuit board mounted in said bottom cover shell, said circuit board comprising winding means and capacitor means, a top cover shell covered on said bottom cover shell over said circuit board, and a communication cable having one end electrically connected to said circuit board and an opposite end terminating in a RJ45 plug for connection to a RJ45 jack, wherein said circuit board comprises a first RJ45 jack electrically connected to said communication cable and adapted to receive the RJ45 plug of an external symmetric digital subscriber line, and a second RJ45 jack electrically connected to said communication cable and adapted to receive the RJ45 plug of a telephone line.

2. The symmetric digital subscriber line telephone filter of claim 1 wherein said bottom cover shell comprises a transverse front opening, and two upright locating posts, said upright locating posts each defining a plug hole; said top cover shell comprises a transverse front opening matching the transverse front opening of said bottom cover shell, and two bottom locating rods respectively fastened to the upright locating posts of said bottom cover shell, said bottom locating rods each having a round pin respectively plugged into the plug hole of each of said upright locating posts; said circuit board is retained between the upright locating pots of said bottom cover shell and the bottom locating rods of said top cover shell, having two through holes for the passing of the round pin of each of the bottom locating rods of said top cover shell.

3. The symmetric digital subscriber line telephone filter of claim 1 wherein said top cover shell comprises a plurality of bottom hook holes, and said bottom cover shell comprises a plurality of top hooks respectively hooked in the bottom hook holes of said top cover shell.
